(19) United States
(12) Patent Application Publication
(10) Pub. No.: US 2019/0369949 A1
(43) Pub. Date: Dec. 5, 2019

(54) METHOD, APPARATUS AND DEVICE FOR PLAYING AUDIO AND STORAGE MEDIUM

(71) Applicant: BAIDU ONLINE NETWORK TECHNOLOGY (BEIJING) CO., LTD., BEIJING (CN)

(72) Inventor: XIANTANG CHANG, BEIJING (CN)

(21) Appl. No.: 16/278,682

(22) Filed: Feb. 18, 2019

(30) Foreign Application Priority Data
May 31, 2018 (CN) 201810556775.5

(51) Int. Cl. G06F 3/16

(52) U.S. Cl. CPC G06F 3/165

(57) ABSTRACT

Embodiments of the present disclosure allow a first audio focus channel to play audio based on an audio focus by receiving a play request from the first audio focus channel, controlling, based on the play request, a second audio focus channel which is currently playing audio to stop playing, and reassigning to the first audio focus channel the audio focus originally assigned to the second audio focus. Therefore, the embodiments of the present disclosure can ensure that the audio for the newly added play request can be played immediately without distinguishment of the type of requested audio, in particular, it is possible to ensure that the newly added audio (Audio) can be played immediately and user experience is improved.

### CROSS-REFERENCE TO RELATED APPLICATION

This application claims priority to Chinese Patent Application No. 201810556775.5, filed on May 31, 2018, which is hereby incorporated by reference in its entirety.

### TECHNICAL FIELD

Embodiments of the present disclosure relate to the field of speaker technologies and, in particular, to a method, apparatus and a device for playing audio and a storage medium.

### BACKGROUND

Audios that can be played over a smart speaker generally include: voice audio converted from text, i.e., tss audio, digital audio (Audio), alarm audio (Alert), and the like. If these audio files are played by the speaker at the same time, there will be a problem of audio mixing, failing to meet the user's expectations.

The existing solution is to set priorities for the above three kinds of audio. When there is new audio to play, the priority of the new audio is compared with the priority of the audio currently being played, and the audio with a higher priority is played. Although this solution solves the problem of audio mixing in the speaker, when the newly added audio has a lower priority, it cannot be played immediately. Especially in the prior art with a lower priority for the audio (Audio), according to the existing technical solution, the newly added audio (Audio) cannot be played immediately if the alarm audio (Alert) or the tts audio is currently played.

### SUMMARY

Embodiments of the present disclosure provide a method, apparatus and a device for playing audio and a storage medium, to ensure that a newly added play request can be played immediately.

A first aspect of the embodiments of the present disclosure provides a method for playing audio, including: receiving a play request from a first audio focus channel; controlling, based on the play request, a second audio focus channel which is currently playing audio to stop playing, and reassigning to the first audio focus channel an audio focus originally assigned to the second audio focus channel such that the first audio focus channel plays audio based on the audio focus.

A second aspect of the embodiments of the present disclosure provides apparatus for playing audio, including: a receiving module, configured to receive a play request from a first audio focus channel; a first assigning module, configured to control, based on the play request, a second audio focus channel which is currently playing audio to stop playing, and reassign to the first audio focus channel an audio focus originally assigned to the second audio focus channel such that the first audio focus channel plays audio based on the audio focus.

A third aspect of the embodiments of the present disclosure provides a device for playing audio, including: one or more processors; one or more display screens configured to display a name of audio which is currently being played and a name of audio to be played next; a storage device, configured to store one or more programs which, when executed by the one or more processors, cause the one or more processors to implement the method as described above in the first aspect.

A fourth aspect of the embodiments of the present disclosure provides a computer readable storage medium having a computer program stored thereon, wherein the program, when executed by the processor, implements the method as described above in the first aspect.

Based on the above aspects, the embodiments of the present disclosure allow a first audio focus channel to play audio based on an audio focus by receiving a play request from the first audio focus channel, controlling, based on the play request, a second audio focus channel which is currently playing audio to stop playing, and reassigning to the first audio focus channel the audio focus originally assigned to the second audio focus channel. Therefore, the embodiments of the present disclosure can ensure that the audio for the newly added play request can be played immediately without distinguishment of the type of requested audio, in particular, it is possible to ensure that the newly added audio (Audio) can be played immediately and user experience is improved.

It is to be understood that contents described above in the summary portion are not intended to limit key or important features in the embodiments of the present disclosure, nor intended to limit the scope thereof. Other features of the present disclosure will be readily understood with reference to the following description.

### DESCRIPTION OF DRAWINGS

FIG. 1 is a flow chart of a method for playing audio according to an embodiment of the present disclosure;

FIG. 2 is a flow chart of a method for releasing an audio focus assigned to a second audio focus channel according to an embodiment of the present disclosure;

FIG. 3 is a schematic diagram of a pushing and popping method for an audio focus channel according to an embodiment of the present disclosure;

FIG. 4 is a schematic structural diagram of apparatus for playing audio according to an embodiment of the present disclosure; and

FIG. 5 is a schematic structural diagram of apparatus for playing audio according to an embodiment of the present disclosure.

### DESCRIPTION OF EMBODIMENTS

The embodiments of the present disclosure will be described in more detail below with reference to the accompanying drawings. Although certain embodiments of the present disclosure are shown in the drawings, it should be understood that the present disclosure may be embodied in a variety of forms and should not be construed as being limited to the embodiments set forth herein. Instead, the embodiments are provided for a more thorough and complete understanding of this disclosure. It should be understood that the drawings and the embodiments of the present disclosure are intended to be illustrative only and not to limit the scope of the present disclosure.

The terms such as “first”, “second”, “third”, “fourth” and the like (if any) in the specification, claims and the above drawings are used to distinguish similar objects, but not necessarily to describe a particular order or precedence order. It should be understood that the data so used are interchangeable as appropriate, such that the embodiments of the present disclosure described herein can be implemented, for instance, in an order other than those illustrated or described herein. In addition, the terms “comprise”, “have” and any variation thereof are intended to cover a non-exclusive inclusion, for instance, processes, methods, systems, products or devices including a series of steps or units are not necessarily limited to those steps or units explicitly listed herein, but which may include other steps or units not explicitly listed or inherent to these processes, methods, products or devices.

For ease of understanding, technical terms involved in the embodiments of the present disclosure are first explained below:

1. Audio Focus, a necessary tool/condition for playing audio. There is only one audio focus in the entire audio playing scheme.

2. Audio Focus Channel, used for playing audio. When there is new audio to be played, it is necessary to send a play request via the audio focus channel to an Audio Focus Manager which determines, according to a preset policy, whether to assign an audio focus to the audio focus channel. If the audio focus manager assigns the audio focus to the audio focus channel, then the audio focus channel enters a preset data stack and plays audio on the top of the data stack based on the audio focus, where a type of audio which can be played by the audio focus channel needs to be registered at the Audio Focus Manager in advance. Audio types involved in the embodiments of the present disclosure include but are not limited to tts audio, audio (Audio), and alarm audio (Alert).

3. Audio Focus Manager, including the audio focus and the data stack involved in the above description.

In the prior art, in order to solve the audio mixing problem resulting from simultaneously playing multiple segments of audio over one audio playing system, a priority method is generally used to play a segment of audio with the highest priority among the multiple segments of audio. Currently, in such a playing scheme, the tts audio is generally provided with a higher priority than the alarm audio (Alert) which is provided with a higher priority than the audio (Audio). Based on such priority setting, a specific audio playing scheme in the prior art is as follows:

When a new audio focus channel a sends a play request to the audio focus manager, the audio focus manager determines whether an audio focus channel b is playing audio in the data stack, if not, the audio focus is assigned to the audio focus channel a which enters the top of the data stack to play the audio. If the audio focus channel b is playing audio at the top of the data stack, then the priority of the audio played by the audio focus channel b is compared with the priority of the audio to be played by the audio focus channel a, if the priority of the former is higher than the priority of the latter, then the audio focus manager rejects the play request from the audio focus channel a; if the priority of the former is lower than the priority of the latter, then the audio focus is assigned to the audio focus channel a, at this point, the audio focus channel b loses the audio focus, and it can be determined, by calling a preset function, whether the audio played by the audio focus channel b belongs to a preset type of replayable audio, if yes, then the audio focus channel b is controlled to stop playing and the audio focus channel b is sunk into the data stack such that the audio focus channel a is at the top of the stack. After the audio focus channel a finishes playing the audio, the audio focus channel a pops out of the stack, and the audio focus channel b resumes the playing at the top of the stack; if the audio played by the audio focus channel b does not belong to a type of replayable audio, then after the audio focus channel b is controlled to stop playing, the audio focus channel b is controlled to pop out of the stack, at this point, the audio focus channel b cannot replay the audio.

According to the above technical solution, since the prior art relies on preset priority information, when a new audio focus channel sends a play request, the new audio focus channel cannot play audio if the audio to be played by the new audio focus channel has a lower priority than the audio that is currently being played, which seriously degrades the user experience. Especially in the prior art where the priority of the audio (Audio) is very low, when there is a request for playing the newly added audio, a playing failure tends to occur.

With regard to the above problem in the prior art, an embodiment of the present disclosure provides a method for playing audio, according to which a priority is not set for an audio type as in the prior art, but a form of immediate play is used, i.e., upon receiving a play request, a play operation which is currently being performed is immediately suspended or terminated, and an audio focus is assigned to the play request. Therefore, it is possible to avoid a failure of immediately playing a type of audio with a lower priority resulting from the case in the prior art that a type of a requested audio has a lower priority than a type of audio that is currently being played, thereby effectively improving the user experience.

The technical solution in the embodiments of the present disclosure will be specifically described below with reference to the accompanying drawings.

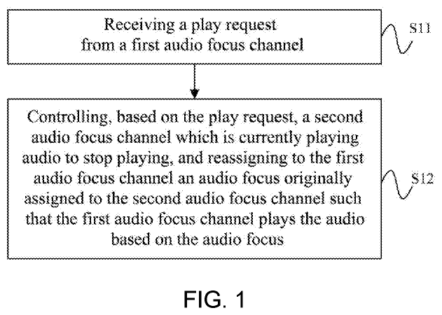

FIG. 1 is a flow chart of a method for playing audio according to an embodiment of the present disclosure. The method may be performed by apparatus for playing audio. With Reference to FIG. 1, the method includes steps S11-S12:

S11: receiving a play request from a first audio focus channel.

S12: controlling, based on the play request, a second audio focus channel which is currently playing audio to stop playing, and reassigning to the first audio focus channel an audio focus originally assigned to the second audio focus channel such that the first audio focus channel plays the audio based on the audio focus.

The “first audio focus channel” and the “second audio focus channel” in this embodiment are named only for distinguishing an audio focus channel that is currently being played the audio from an audio focus channel that sends a play request, and there is no other meaning.

The technical scenario set in this embodiment is that a play request is received from the first audio focus channel when the second audio focus channel is playing the audio, at this point, the second audio focus channel is at the top of a preset data stack and has an audio focus, while the first audio focus channel is outside the data stack and does not have the audio focus (there is only a unique audio focus in the entire audio playing scheme). This embodiment is an improvement based on the basic architecture of the prior art, which is mainly directed at removing division of audio priorities in the prior art, solving the problem in the above scenario via technical means as to how to make the first audio focus channel immediately obtain a playing permission and immediately perform a playing operation together with the problem as to how to cope with the second audio focus channel on the above basis.

In order to be able to clearly illustrate the technical solution in this embodiment, a specific example will be described below:

It is assumed that in this example, the audio requested by the first audio focus channel is audio (Audio), and the second audio focus channel is playing the alarm audio (Alert). At this point, in order to immediately play the audio (Audio), it is necessary to first control the second audio focus channel to stop playing the alarm audio (Alert), and then release the audio focus owned by the second audio focus channel so that the second audio focus channel loses the audio focus. However, in this embodiment, there may be multiple ways to cope with the second audio focus channel that loses the audio focus. For instance, in one possible design, a pop operation may be performed on the second audio focus channel to discard the alarm audio (Alert) released from the data stack and played by the second audio focus channel, moreover, after the second audio focus channel pops out of the stack, the first audio focus channel is placed at the top of the data stack, and the audio focus is assigned to the first audio focus channel so that the first audio focus channel plays the audio (Audio). In another possible design, the second audio focus channel which loses the audio focus may be sunk into the data stack, then the first audio focus channel is placed at the top of the data stack, and the audio focus is assigned to the first audio focus channel such that the first audio focus channel plays the audio (Audio). After finishing playing the audio (Audio), the first audio focus channel is performed with a pop operation and an audio focus releasing operation, moreover, after the first audio focus channel pops out of the stack, the second audio focus channel in the data stack is placed at the top, and the audio focus is reassigned to the second audio focus channel such that the second audio focus channel replays the alarm audio (Alert). However, it should be noted that if the first audio focus channel pops out of the stack while the second audio focus channel has not started to replay and at this point a new play request is received, then the audio focus can be preferentially assigned to the newly received play request, further ensuring that the audio for the new play request can be immediately played.

As can be seen from the above example, regardless of the use of which method provided above to cope with the second audio focus channel, in this embodiment, the newly received play request can get an immediate response and it is ensured that the audio for the new play request can be played immediately. Certainly, the above description is only illustrative, but is not intended to limit the embodiments of the present disclosure. In fact, segments of audio played by the first audio focus channel and the second audio focus channel in an actual scenario may be any type of audio, and the segments of audio played by the first audio focus channel and the second audio focus channel may be of the same type or of different types.

In the embodiment, further, in order to provide friendly user interaction, after the audio focus is assigned to the first audio focus channel, the name of the audio played by the first audio focus channel may also be displayed, for instance, in the above example, the first audio focus channel plays the audio (Audio), and the name of this audio can be carried in apparatus for playing audio or displayed by an external display screen. Even in the second case of the above example, if no pop operation is performed after the second audio focus channel loses the audio focus, instead it is sunk into the data stack, then in this embodiment, the name of the audio played by the second audio focus channel may also be displayed as the name of audio to be played next.

The present embodiment allows a first audio focus channel to play audio based on an audio focus by receiving a play request from the first audio focus channel, controlling, based on the play request, a second audio focus channel which is currently playing audio to stop playing, and reassigning to the first audio focus channel the audio focus originally assigned to the second audio focus. Therefore, the present embodiment can ensure that the audio for the newly added play request can be played immediately without distinguishment of the type of requested audio, in particular, it is possible to ensure that the newly added audio (Audio) can be played immediately and user experience is improved.

The above embodiment is further optimized and extended with reference to the accompanying drawings.

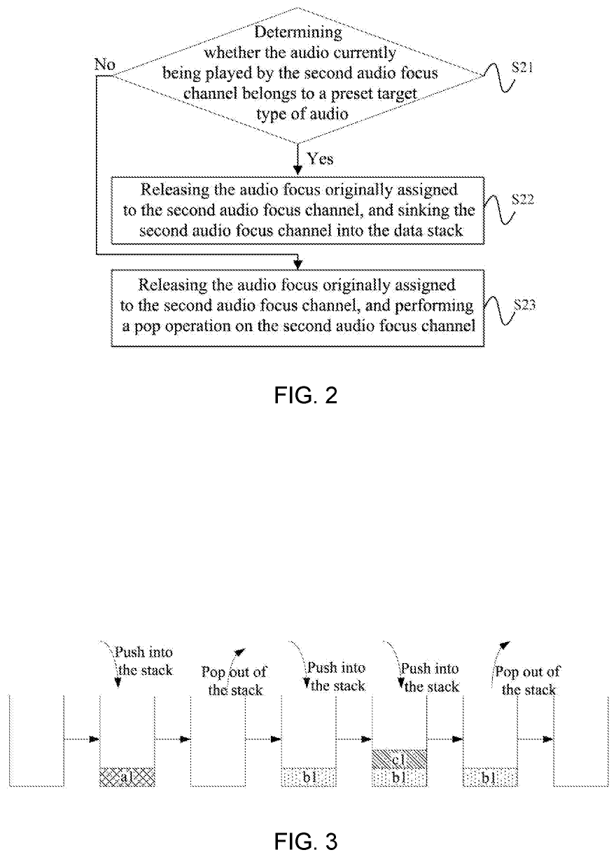

FIG. 2 is a flow chart of a method for releasing an audio focus assigned to a second audio focus channel according to an embodiment of the present disclosure. As shown in FIG. 2, based on the embodiment of FIG. 1, the method includes steps S21-S23:

S21: determining whether the audio currently being played by the second audio focus channel belongs to a preset target type of audio, and if yes, performing step S22, otherwise performing step S23.

S22: releasing the audio focus originally assigned to the second audio focus channel, and sinking the second audio focus channel into the data stack.

S23: releasing the audio focus originally assigned to the second audio focus channel, and performing a pop operation on the second audio focus channel.

The target type of audio mentioned in this embodiment refers to a preset type of replayable audio. The target type of audio includes one or more types of audio, and the target audio type can be set as appropriate, to which no specific restriction will be made in this embodiment.

In addition, in the present embodiment, it is provided that a playing operation is performed at the top of the data stack for all audio focus channels which obtain the audio focus. That is to say, when apparatus for playing audio receives the play request from the first audio focus channel, the second audio focus channel is at the top of the data stack.

For the sake of understanding, the method for playing the audio of this embodiment will be described in detail below with one possible example:

Specifically, FIG. 3 is a schematic diagram of a pushing and popping method for an audio focus channel according to an embodiment of the present disclosure. In the scenario shown in FIG. 3, the data stack is empty in the initial state, that is, there is no data in the data stack, and no audio is played at this time. Further, it is assumed that there is a segment of tts audio to be played at this point, the audio focus channel a1 for playing the tts audio sends a play request to an apparatus for playing audio. Since no audio is being played at this time, the apparatus for playing the audio directly controls the audio focus channel a1 to enter the data stack and assigns the audio focus to the audio focus channel a1 so that the audio focus channel a1 plays the tts audio at the top of the stack. If there is still no new play request even until the tts audio finishes being played, then a pop operation is performed on the focus channel a1 at the point when the tts audio finishes being played. After that, it is assumed that there is another segment of audio (Audio) to be played, then the audio focus channel b1 for playing the audio (Audio) sends a play request to the apparatus for playing the audio. The apparatus for playing the audio controls the audio focus channel b1 to be pushed into the stack, and assigns the audio focus to the audio focus channel b1 such that the audio focus channel b1 plays the audio (Audio). If a request to play alarm audio (Alert) is received from the audio focus channel c1 when the audio (Audio) has not finished yet, since the audio (Audio) is a preset type of playable audio, the apparatus for playing the audio sinks the audio focus channel b1 into the data stack after releasing the audio focus originally assigned to the audio focus channel b1, at this point, the audio focus channel c1 enters the top of the data stack, and plays the alarm audio (Alert) based on the audio focus assigned to it by the apparatus for playing the audio. After the alarm audio (Alert) finishes, the audio focus channel c1 pops out of the stack, and the audio focus is reassigned to the audio focus channel b1. At this point, the audio focus channel b1 is replaced at the top of the stack, and replays the audio (Audio) at the top of the stack. After the audio (Audio) also finishes being played, the audio focus channel b1 pops out of the stack. That is to say, the above example can be generalized as: after finishing playing the audio, the first audio focus channel releases the audio focus assigned thereto, and a pop operation is performed on the first audio focus channel. In addition, if the second audio focus channel is still in the data stack at this point, then the second audio focus channel is placed at the top of the data stack, and the audio focus is reassigned to the second audio focus channel such that the second audio focus channel replays the audio.

In this embodiment, the type of audio being played by the second audio focus channel is determined, if the audio being played belongs to a preset target type of replayable audio, the second audio focus channel for which the playing is suspended is sunk into the data stack so that the second audio focus channel can replay the audio based on the regained audio focus after the first audio focus channel finishes playing. Therefore, it can be ensured that the unfinished audio is not lost while the audio for the new play request is played immediately, and is replayed after the audio for the newly added play request finishes being played, thereby improving user experience.

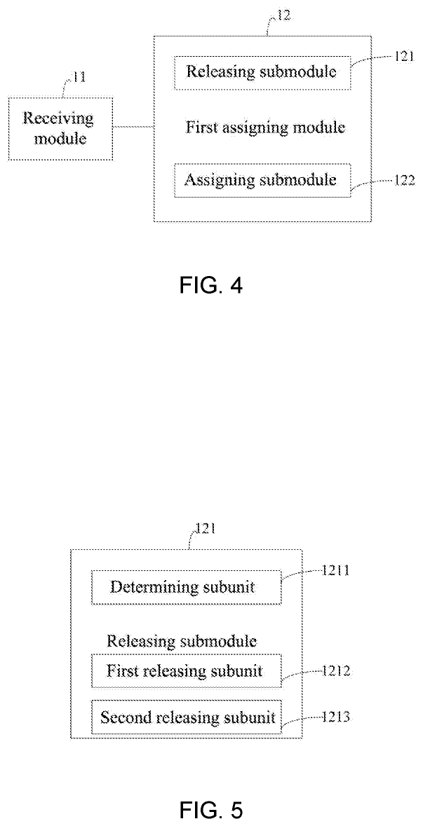

FIG. 4 is a schematic structural diagram of apparatus for playing audio according to an embodiment of the present disclosure. As shown in FIG. 4, the apparatus includes:

a receiving module 11, configured to receive a play request from a first audio focus channel; and

a first assigning module 12, configured to control, based on the play request, a second audio focus channel which is currently playing audio to stop playing, and reassign to the first audio focus channel an audio focus originally assigned to the second audio focus channel such that the first audio focus channel plays the audio based on the audio focus.

In a possible design, the first assigning module 12 includes:

a releasing submodule 121, configured to release the audio focus originally assigned to the second audio focus channel;

an assigning submodule 122, configured to reassign the audio focus to the first audio focus channel and place the first audio focus channel at a top of a preset data stack such that the first audio focus channel plays the audio based on the audio focus.

In one possible design, the apparatus further includes:

a first display module, configured to display the name of the audio played by the first audio focus channel.

In one possible design, the apparatus further includes:

a second display module, configured to display a name of the audio played by the second audio focus channel as a name of audio to be played next.

The apparatus for playing the audio provided in this embodiment can be used to perform the method in the embodiment of FIG. 1, and implementation manners and beneficial effects of the apparatus are similar to those in the method embodiment, for which details will not be described.

FIG. 5 is a schematic structural diagram of apparatus for playing audio according to an embodiment of the present disclosure. As shown in FIG. 5, on the basis of the embodiment of FIG. 4, the releasing submodule 121 includes:

a determining subunit 1211, configured to determine whether the audio currently being played by the second audio focus channel belongs to a preset target type of audio;

a first releasing subunit 1212, configured to: when the audio currently being played by the second audio focus channel belongs to the target type of audio, release an audio focus originally assigned to the second audio focus channel, and sink the second audio focus channel into the data stack; and

a second releasing subunit 1213, configured to: when the audio currently being played by the second audio focus channel does not belong to the target type of audio, release the audio focus originally assigned to the second audio focus channel, and perform a pop operation on the second audio focus channel;

where when the play request is received from the first audio focus channel, the second audio focus channel is at the top of the preset data stack.

In one possible design, the apparatus further includes:

a releasing module, configured to release the audio focus assigned to the first audio focus channel after the first audio focus channel finishes playing the audio; and an executing module, configured to perform a pop operation on the first audio focus channel.

In one possible design, the apparatus further includes:

a second assigning module, configured to: when the second audio focus channel is still in the data stack, place the second audio focus channel at the top of the data stack, and reassign the audio focus to the second audio focus channel such that the second audio focus channel replays the audio.

In one possible design, the apparatus further includes:

a third assigning module, configured to: when there is no audio focus channel which is currently playing audio, assign the audio focus directly to the first audio focus channel such that the first audio focus channel plays the audio based on the audio focus.

The apparatus for playing the audio provided in this embodiment can be used to perform the method in the embodiment of FIG. 2, and implementation manners and beneficial effects of the apparatus are similar to those in the method embodiment, for which details will not be described.

An embodiment of the present disclosure further provides a device for playing audio, including:

one or more processors;

one or more display screens, configured to display a name of audio which is currently being played and a name of audio to be played next; and

a storage device, configured to store one or more programs which, when executed by the one or more processors, cause the one or more processors to implement the method of any of the above embodiments.

An embodiment of the present disclosure further provides a computer readable storage medium having a computer program stored thereon, where the program, when executed by the processor, implements the method described in any of the above embodiments.

The functions described above herein may be performed at least in part by one or more hardware logic components. For instance, without limitation, exemplary types of hardware logic components that may be used include: the field programmable gate array (FPGA), application specific integrated Circuit (ASIC), application specific standard product (ASSP), system on chip (SOC), complex programmable logic device (CPLD) and the like.

Program codes for implementing the methods of the present disclosure can be written in any combination of one or more programming languages. These program codes may be provided to a processor or a controller of a general purpose computer, a special purpose computer or other programmable data processing apparatus such that the program codes, when executed by the processor or the controller, enable functions/operations specified in the flow charts and/or block diagrams to be implemented. The program codes may be executed entirely over a machine, partly over the machine, or executed partly over the machine and executed partly over a remote machine as a stand-alone software package, or executed entirely over the remote machine or a server.

In the context of the present disclosure, a machine readable medium may be a tangible medium that can contain or store a program for use with or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage media may include an electrical connection based on one or more wires, a portable computer disk, a hard disk, a random access memory (RAM), a read only memory (ROM), an erasable programmable read only memory (EPROM or a flash memory), an optical fiber, a portable compact disk read only memory (CD-ROM), an optical storage device, a magnetic storage device, or any suitable combination of the foregoing.

In addition, the operations are depicted in a particular order, which however should be interpreted as requiring that such operations should be performed in the particular order as shown or in a sequential order, or that all illustrated operations should be performed to achieve the desired results. Multitasking and parallel processing may be advantageous under certain circumstances. Likewise, although several specific implementation details are included in the above discussion, these details should not be construed as a limitation to the scope of the disclosure. Certain features that are described in the context of separate embodiments may also be implemented in combination in a single implementation. Conversely, various features that are described in the context of a single implementation may also be implemented in a plurality of implementations, either individually or in any suitable sub-combination.

Although the subject matter has been described in language specific to structural features and/or methodological acts, it should be understood that the subject matter defined in the appended claims is not limited to the above specific features or acts. Instead, the specific features and acts described above are merely exemplary forms for implementing the claims.

What is claimed is:

1. A method for playing audio, comprising:
receiving a play request from a first audio focus channel;
controlling, based on the play request, a second audio focus channel which is currently playing audio to stop playing, and reassigning to the first audio focus channel an audio focus originally assigned to the second audio focus channel such that the first audio focus channel plays audio based on the audio focus.

2. The method according to claim 1, wherein the reassigning to the first audio focus channel the audio focus originally assigned to the second audio focus channel such that the first audio focus channel plays the audio based on the audio focus comprises:
releasing the audio focus originally assigned to the second audio focus channel;
reassigning the audio focus to the first audio focus channel and placing the first audio focus channel at a top of a preset data stack such that the first audio focus channel plays the audio based on the audio focus.

3. The method according to claim 1, after the reassigning to the first audio focus channel the audio focus originally assigned to the second audio focus channel, further comprising:
displaying a name of the audio played by the first audio focus channel.

4. The method according to claim 2, wherein the releasing the audio focus originally assigned to the second audio focus channel comprises:
determining whether the audio currently being played by the second audio focus channel belongs to a preset target type of audio;
wherein if the audio currently being played by the second audio focus channel belongs to a preset target type of audio, then releasing the audio focus originally assigned to the second audio focus channel, and sinking the second audio focus channel into the data stack; and
if the audio currently being played by the second audio focus channel does not belong to the target type of audio, then releasing the audio focus originally assigned to the second audio focus channel, and performing a pop operation on the second audio focus channel;
wherein when the play request is received from the first audio focus channel, the second audio focus channel is at the top of the preset data stack.

5. The method according to claim 4, wherein when the audio currently being played by the second audio focus channel belongs to the target type of audio, the method further comprises:
displaying a name of the audio played by the second audio focus channel as a name of audio to be played next.

6. The method according to claim 4, wherein after the reassigning the audio focus to the first audio focus channel and placing the first audio focus channel at the top of the data stack such that the first audio focus channel plays the audio based on the audio focus, the method further comprises:
releasing the audio focus assigned to the first audio focus channel after the first audio focus channel finishes playing the audio; and
performing a pop operation on the first audio focus channel.

7. The method according to claim 6, wherein after the releasing the audio focus assigned to the first audio focus channel after the first audio focus channel finishes playing the audio, the method further comprises:
if the second audio focus channel is still in the data stack, then placing the second audio focus channel at the top of the data stack, and reassigning the audio focus to the second audio focus channel such that the second audio focus channel replays the audio.

8. The method according to claim 1, wherein after the receiving the play request from the first audio focus channel, the method further comprises:
if there is no audio focus channel which is currently playing audio, then assigning the audio focus directly to the first audio focus channel such that the first audio focus channel plays the audio based on the audio focus.

9. An apparatus for playing audio, comprising: a processor and a computer-readable medium for storing program codes, which, when executed by the processor, cause the processor to:
receive a play request from a first audio focus channel; and
control, based on the play request, a second audio focus channel which is currently playing audio to stop playing, and reassign to the first audio focus channel an audio focus originally assigned to the second audio focus channel such that the first audio focus channel plays audio based on the audio focus.

10. The apparatus according to claim 9, wherein the program codes further cause the processor to:
release the audio focus originally assigned to the second audio focus channel;
reassign the audio focus to the first audio focus channel and place the first audio focus channel at a top of a preset data stack such that the first audio focus channel plays the audio based on the audio focus.

11. The apparatus according to claim 9, wherein the program codes further cause the processor to:
display a name of the audio played by the first audio focus channel.

12. The apparatus according to claim 10, wherein the program codes further cause the processor to:
determine whether the audio currently being played by the second audio focus channel belongs to a preset target type of audio;
when the audio currently being played by the second audio focus channel belongs to the target type of audio, release the audio focus originally assigned to the second audio focus channel, and sink the second audio focus channel into the data stack; and
when the audio currently being played by the second audio focus channel does not belong to the target type of audio, release the audio focus originally assigned to the second audio focus channel, and perform a pop operation on the second audio focus channel;
wherein when the play request is received from the first audio focus channel, the second audio focus channel is at the top of the preset data stack.

13. The apparatus according to claim 12, wherein the program codes further cause the processor to:
display a name of the audio played by the second audio focus channel as a name of audio to be played next.

14. The apparatus according to claim 12, wherein the program codes further cause the processor to:
release the audio focus assigned to the first audio focus channel after the first audio focus channel finishes playing the audio; and
perform a pop operation on the first audio focus channel.

15. The apparatus according to claim 14, wherein the program codes further cause the processor to:
when the second audio focus channel is still in the data stack, place the second audio focus channel at the top of the data stack, and reassign the audio focus to the second audio focus channel such that the second audio focus channel replays the audio.

16. The apparatus according to claim 9, wherein the program codes further cause the processor to:
when there is no audio focus channel which is currently playing audio, assign the audio focus directly to the first audio focus channel such that the first audio focus channel plays the audio based on the audio focus.

17. A device for playing audio, comprising:
one or more processors;
one or more display screens, configured to display a name of audio which is currently being played and a name of audio to be played next; and
a storage device, configured to store one or more programs which, when executed by the one or more processors, cause the one or more processors to implement the method according to claim 1.
